(19) United States
(12) Patent Application Publication
(10) Pub. No.: US 2017/0132631 A1
(43) Pub. Date: May 11, 2017

(54) SYSTEM AND METHOD FOR USER IDENTITY VALIDATION FOR ONLINE TRANSACTIONS

(71) Applicant: GULA CONSULTING LIMITED LIABILITY COMPANY, Dover (DE)

(72) Inventor: Michael J. Schultz, San Jose, CA (US)

(73) Assignee: GULA CONSULTING LIMITED LIABILITY COMPANY, Dover (DE)

(21) Appl. No.: 15/232,406

(22) Filed: Aug. 9, 2016

Related U.S. Application Data
(63) Continuation of application No. 12/118,135, filed on May 9, 2008, now abandoned.
Application No. 12/118,135 is a continuation-in-part of application No. 11/789,495, filed on Apr. 24, 2007, now abandoned.
(60) Provisional application No. 60/863,746, filed on Oct. 31, 2006.
(60) Provisional application No. 61/046,383, filed on Apr. 18, 2008.

(51) Int. Cl. G06Q 20/40; G06Q 20/02

(52) U.S. Cl. CPC G06Q 20/4014; G06Q 20/02; G06Q 20/4016

(57) ABSTRACT

A process is proposed that collects minimal personal data of an individual who is conducting a transaction online, either directly or from a third party. The data collected is then matched to a known and validated public profile stored in public and private databases, and a set of Knowledge Based Authentication (KBA) questions are generated from the identified databases and presented to (e.g., displayed or read to via computer generated voice) the consumer for validation of the consumer's identity. Once the individual's identity has been validated, the online transaction by the person can then be authorized.

### RELATED APPLICATIONS

This application is a continuation of U.S. patent application Ser. No. 12/118,135, filed May 9, 2008, which is a continuation in part of U.S. patent application Ser. No. 11/789,495, filed Apr. 24, 2007, entitled “System and Method for User Identity Authentication via Mobile Communication Devices” by Michael J. Schultz, which claims priority to U.S. Provisional Patent Application No. 60/863,746, filed Oct. 31, 2006 and is hereby incorporated herein by reference.

This application also claims benefit under 35 USC §119(e) to U.S. Provisional Patent Application No. 61/046,383, filed Apr. 18, 2008, entitled “Digital Identity Validation for Fraud Protection” by Michael J. Schultz, and, entitled “Integrated Mobile Communications System Using User-Guided Search Function and Providing Interactive Communication Over Disparate Communications Platforms” by Michael Shultz, and is hereby incorporated herein by reference.

### BACKGROUND

In prior times, identity related fraud was limited to transactions where the fraudulent party was always present to perpetrate the identity fraud whether by means of forged checks, improper use of bank or credit accounts, scamming money off an unsuspecting victim or pretending to be someone other than who that person was in real life to obtain funds or perpetrate harm. Since the advent of widespread use of the internet in early 1990's, the internet has served as a platform for a variety of e-commerce venues, which allows and even encourages more participation in various aspects of digital life such as online banking, buying products from online merchants via credit cards, sending text messages to one another, interacting with others in social networks either as an individual or part of a group. FIG. 1 shows an example of a typical credit-based purchase flow, in which a credit card issuing bank 102 issues a credit card to a customer, who later uses the credit card to purchase a product or service on credit at merchant 104. Here, the merchant 104 is a business—or in terms of e-commerce, a Web site—that accepts credit or debit cards in exchange for goods or services, and the merchant has an established relationship with an acquiring bank 106 in order to process transactions and obtain cash from credit card purchases. The acquiring bank 106 can be a member of a card scheme(s) such as MasterCard and/or Visa and maintains merchant relationships and receives all card transactions from the merchant 104. Once the merchant 104 passes information about the transaction to the acquiring bank 106, the acquiring bank 106 sends a request for credit card authorization to the card issuing bank 102 through a secured credit card clearing network. The issuing bank 102 issues an approval or denial code and sends a message back to the acquiring bank 106 at the time of the transaction. The acquiring bank 106 then sends the code back to the merchant 104 to approve or decline the purchase by the customer.

Presently, over 2.5 billion Visa and MasterCard cards issued worldwide are increasingly used online. Crimes related to identity theft have become an increasingly serious threat to those people with lost or stolen credit cards, while 53% of all fraud is done online, representing a multi-billion dollar loss to the industry. Many consumers are protected from financial loss if they report their cards stolen in the first 72 hours, but even then they are obliged to spend many hours trying to reconcile what was their rightful purchases (and liability) to those fraudulently charged against their stolen card.

There are various forms of technologies current employed by online merchants to avoid identity-related fraud and prevent credit card fraud, both in-person and online. Such technologies include but are not limited to, identifying Media Access Control (MAC) address of a device used to participate in a digitally based interaction, sniffing the IP address to confirm if the originating address is the anticipated one, determining the identity by accessing credit reporting agencies, and requesting forensic report of previous purchase discrepancies associated with the user name, data or credit card as well as manual review of purchases including outbound call centers to validate that the consumer has actually placed an order. These technologies are designed to minimize or eliminate human interaction, relying instead of complex algorithms to define if an online user is actually the person they proclaim they are and there is a minimal interaction with the user themselves to prove identity. When it comes to subsequent logins the current processes use PINs or passwords, such as Verified by VISA, there is limited follow up identity verification. In spite of these technologies being applied to prevent fraud, online merchants in the USA and Canada are estimated to have lost over $3.6 billion to online fraud in 2007. Consequently, there is a strong need for an identity verification system, which allows a person's identity to be conveniently and promptly validated when the person initiates any major activities online. The use of information from credit files to verify user identity has been used to authorize access to online accounts for credit file reporting (e.g., Experian at creditexpert.com) or for lost account passwords with a credit card issuer (e.g., Chase at chase.com). However, such information has not been utilized for online transactions due to strict limitations and compliance requirements for such transactions.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

The features and objects of the disclosure are illustrated by way of example in the accompanying drawings. The drawings should be understood as illustrative rather than limiting.

FIG. 1 shows an example of a typical credit-based purchase flow (prior art).

FIG. 2 shows an example of a system to support user identity validation for online transactions.

FIG. 3 depicts a flowchart of an example of a process to support user identity validation for online transactions.

### DETAILED DESCRIPTION OF EMBODIMENTS

The specific embodiments described in this document represent examples or embodiments of the present invention, and are illustrative in nature rather than restrictive. In the following description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the invention. Features and aspects of various embodiments may be integrated into other embodiments, and embodiments illustrated in this document may be implemented without all of the features or aspects illustrated or described.

A process is proposed that collects minimal personal data of an individual who is conducting a transaction online, either directly or from a third party. The data collected is then matched to a known and validated public profile stored in public and private databases, and a set of Knowledge Based Authentication (KBA) questions are generated from the identified databases and presented (e.g., displayed or spoken via computer generated voice) to the consumer for validation of the consumer's identity. Once the individual's identity has been validated, the online transaction by the person can then be authorized.

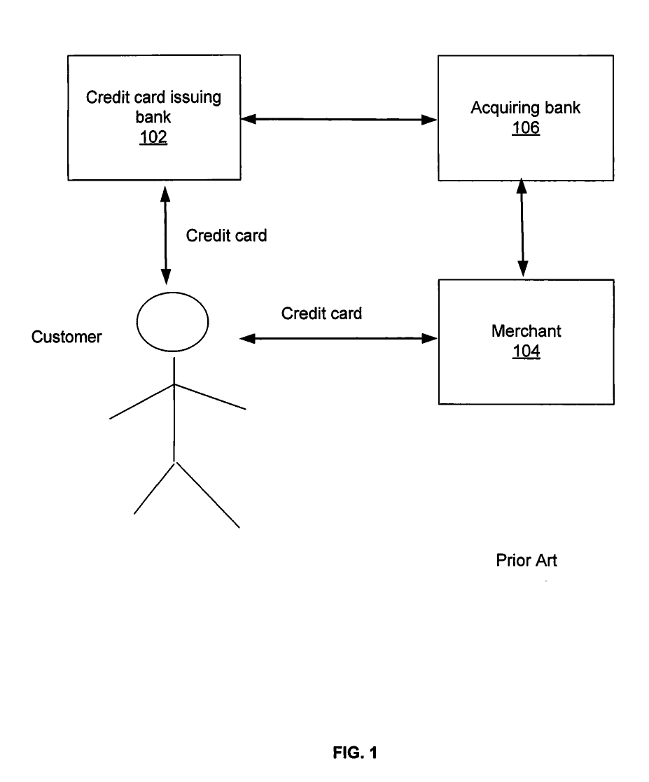

Such a process is relatively unobtrusive and occurs in a relatively short period of time and in person to avoid unnecessary delays that might otherwise be incurred if validation occurs by telephone call, mail, internet, and other traditional validation methods. The process acts as an additional automated layer of protection on top of online transaction procedures typically employed in those instances where an online merchant may believe that a high potential for fraud exists. The process is a fraud prevention tool that uses human interaction (e.g., interaction with the individual initiating a transaction) to shut down credit card fraud. It protects against credit card fraud and identity theft, and prevents unwanted transaction completion from unknown or non-validated people. During its operation, the normal transaction flow between the individual and the merchant as described in FIG. 1 is not affected, making the process inherently ARGOT compliant (wherein ARGOT provides multi-factor authentication, credential management, and digital signature solutions for online transactions). In addition, the process allows the formation and maintenance of online or mobile community groups that require or desire a stringent vetting process to limit access and participation. As used in the present disclosure, the term “validation” or “verification” shall be defined as confirmation of an identity of a user.

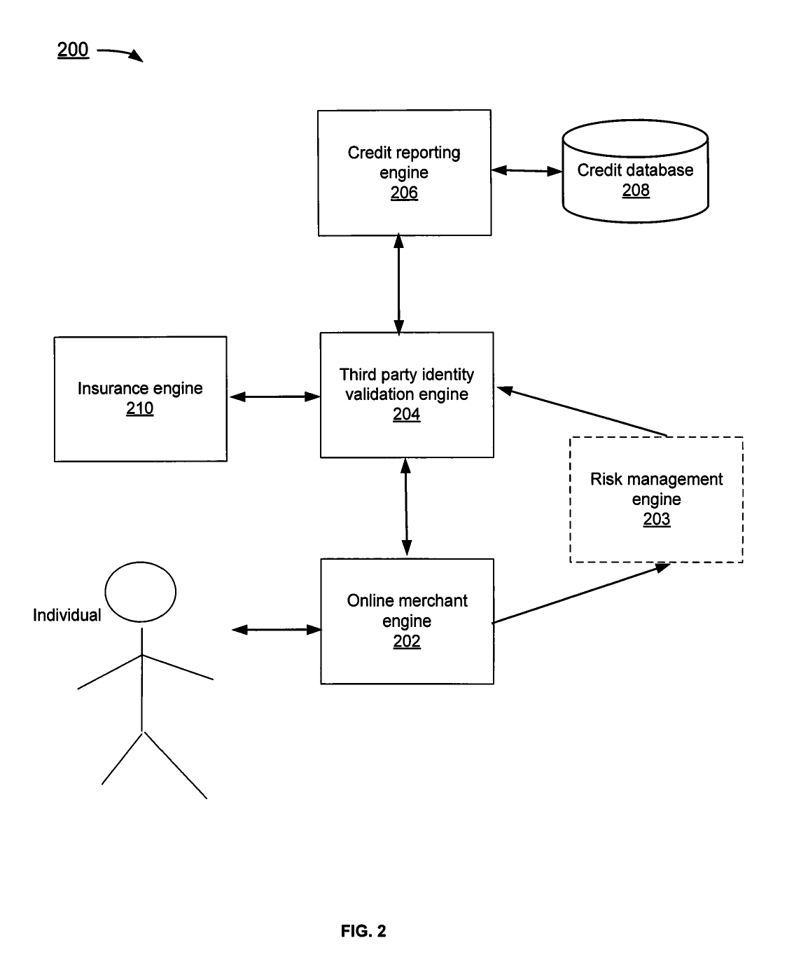

FIG. 2 shows an example of a system to support user identity validation for online transactions. In the example of FIG. 2, the system 200 includes an online merchant engine (or merchant acquiring engine) 202, a third-party validation engine 204, a credit reporting engine 206, a credit database 208 coupled to the credit reporting engine 206, and an insurance engine 210. The term “engine,” as used herein, generally refers to any combination of software, firmware, hardware, or other component that is used to effectuate a purpose.

In the example of FIG. 2, the online merchant engine 202, the third-party validation engine 204, the credit reporting engine 206, and the insurance engine 210 are operable to provide services on behalf of an online merchant, a third party validator, a credit reporting agency, and an insurer, respectively, via one or more hosting devices (hosts). Here, a host can be a computing device, a communication device, a storage device, or any electronic device capable of running software. For non-limiting examples, a computing device can be but is not limited to, a laptop PC, a desktop PC, a tablet PC, or a server machine. A storage device can be but is not limited to a hard disk drive, a flash memory drive, or any portable storage device. A communication device can be but is not limited to a mobile or cellular phone.

In the example of FIG. 2, each of the online merchant engine 202, the third-party validation engine 204, the credit reporting engine 206, the credit database 208, and the insurance engine 210 communicates with others via one or more communication interfaces (not shown). Here, a communication interface is a software component that enables the online merchant engine 202, the third-party validation engine 204, the credit reporting engine 206, the credit database 208, and the insurance engine 210 to reach, communicate with, and/or exchange information/data/files with each other via a network by invoking agreed-upon interfaces, such as Application Programming Interfaces (APis), and following certain agreed-upon communication protocols, such as TCP/IP protocol, wireless protocol, or any standard communication protocols.

In the example of FIG. 2, each of the online merchant engine 202, the third-party validation engine 204, the credit reporting engine 206, the credit database 208, and the insurance engine 210 communicates with others over a network (not shown). Here, the network can be a communication network based on certain communication protocols, such as TCP/IP protocol. Such network can be, but is not limited to, internet, intranet, wide area network (WAN), local area network (LAN), wireless network, Bluetooth, WiFi, WiMAX, satellite, cellular, and mobile communication networks. The physical connections of the network and the communication protocols are well known to those of skill in the art.

In some embodiments, some or all of the online merchant engine 202, the third-party validation engine 204, the credit reporting engine 206, the credit database 208, and the insurance engine 210 communicates with each other via one or more virtual private networks (VPN), which can be a high-speed dedicated network that permits the transfer of large amounts of data with limited transmission lag time. Through the use of a private and dedicated network, or shared network with aggregate high bandwidth and potentially Quality of Service (QoS) guarantees or priorities, communications of all forms are received by recipient in a near instantaneous form with little perceptible delay. In addition, the parties may communicate with each other via an e-mail, an instant messaging (IM), short messaging system (SMS), a multimedia messaging system (MMS), Wireless Application Protocol (WAP), or any other method suitable for distributed or mobile communication. This variety enables communication between the parties even on disparate platforms and mobile operating systems, to communicate via one or more of: structured data, numbers, text, voice, and images. In one embodiment, the communication is nearly instantaneous. However, the approach also works in asynchronous environments. For example, an individual may receive a message, such as via email, which initiates an interaction between the individual and the third-party validation engine 204, wherein the security of that interaction is enhanced by that interaction being time limited.

In the example of FIG. 2, the online merchant engine 202 first follows the typical credit authorization flow by requesting and authenticating from an individual who is initiating an online transaction with the online merchant engine 202 certain information required to complete the transaction. Such information can be personal data of the individual, which may include but is not limited to, name, address, telephone number, e-mail address, credit card type, credit card number, security code, and expiration date. The online merchant engine 202 may then authenticate the information via the credit reporting engine 206 to ensure that the information provided by the individual is valid. In addition, the online merchant engine 202 may adopt one or more of the following technologies to prevent credit fraud: identifying MAC address of a device used by the individual to initiate the transaction, sniffing the IP address of the device to confirm if the originating address is the anticipated one, requesting forensic report of previous purchase discrepancies associated with the individual's name, data or credit card as well as manual review of purchases made by the individual.

Once the transaction is authorized based on typical credit authorization flow, the online merchant engine 202 may either immediately approve the transaction with the individual or request additional validation of the identity of the individual from the third-party identity validation engine 204 if the merchant believes that a high risk for fraud exists. In one embodiment, the online merchant engine 202 may identify the risk of fraud by the individual by evaluating a set of business rules and limitations and determining if these rules are met. For non-limiting examples, such rules and limitations can include one or more of: whether the single transaction amount is over a preset limit (e.g., $500), whether the accumulated transaction amount for a given time period (e.g., a day) exceeds a preset limit on the card, whether multiple transaction are attempted over a given time period (e.g., a hour), and whether the transaction is originated outside of a certain geographic area where transactions by the individual usually originate as identified by the IP address from which the online transaction is being initiated. In one embodiment, when the individual plans to travel outside the local geographical area, the individual may notify one or more of the issuing bank (the bank that issued the credit card), third-party identity validation engine 204, or the credit reporting engine 206, or the entity operating the corresponding engine. In one embodiment, the business rules are evaluated by or on behalf of the issuing bank. In one embodiment, the issuing bank invokes the third-party identity validation engine 204.

In the example of FIG. 2, the third-party identity validation engine 204 validates the identity of the individual when the fraud risk of the individual is deemed high (such as by a numerical risk score for the transaction being above a threshold). The numerical risk score may be computed by a risk management engine 203, which may be located separately from the online merchant engine 202. More specifically, the identity validation engine 204 is given certain information from the online merchant engine that is requesting the identity validation, wherein such information may include but is not limited to, name, address, and telephone number of the individual. The identity validation engine 204 then provides such information of the individual to the credit reporting engine 206 either individually or as a batch, which provides a set of KBA questions in return. In one embodiment, the credit reporting engine 206 is the issuing bank (the bank that issued the individual's credit card). The identity validation engine 204 then provides the set of KBA questions to the individual via the online merchant engine 202, which, at least in some embodiments, may then display the KBA questions automatically to the individual on a web page or other interface separate from order confirmation. The KBA questions may be submitted to the individual through a different device than used for the transaction. For a non-limiting example, the individual's cellular phone may receive a message to validate a transaction initiated at a brick-and-mortal merchant or an email message may be sent to the individual to validate a web-based transaction. In some embodiments, the third-party identity validation engine 204 may directly provide the KBA questions to the individual and receive responses without using the online merchant engine 202 as an intermediary.

In the example of FIG. 2, the third-party identity validation engine 204 retrieves the responses to the questions from the individual, if such responses are provided in a timely manner, for the credit reporting engine 206 to review. For example, the individual has a timed window to correctly reply to the questions after which they are graded for accuracy or the validity of his/her identity will be denied by the identity validation engine 204. The window can be measured in minutes, to avoid the individual from “looking up” the answers to the KBA questions by referencing to other sources, such as the actual credit report from which the KBA questions are generated. In the meantime, the third-party identity validation engine 204 may block the transaction initiated by the individual temporarily until his/her identity is validated.

In one embodiment of FIG. 2, the credit reporting engine 206 performs a reverse lookup for the individual's social security number using the individual's information provided by the identity validation engine 204. In another embodiment, the third-party identity validation engine receives the individual's social security number from the issuing bank (the bank that issued the individual's credit card). Based on the individual's social security number, the credit reporting engine 206 is able to retrieve the individual's profile and/or credit history from the credit database 208, and generates a set of KBA questions that are specifically tailored based on the individual's profile and/or credit history. For non-limiting examples, the set of KBA questions may include but are not limited to, a specific transaction on a specific date, the location of a recent transaction, prior addresses or phone numbers, etc. Once the individual's responses to the set of KBA questions are retrieved and provided to the credit reporting engine 206 by the identity validation engine 204, the credit reporting engine 206 may rate or grade the responses and provide the grading back to the identity validation engine 204.

In one embodiment, the set of KBA questions chosen varies from one transaction to another, to prevent those answers being used to satisfy subsequent validation requests. Here, the set of KBA questions does not contain personally identifying information. In one embodiment, when a credit card account has multiple authorized users, that information is taken into account in choosing the KBA questions. In one embodiment, when a credit card has multiple authorized users, that information in taken into account when retrieving the credit profile and/or credit history corresponding to the individual. In one embodiment, when a credit card has multiple authorized users, the credit profile and/or credit history corresponding each of the authorized users is retrieved.

In the example of FIG. 2, the credit database 208 coupled to the credit reporting engine 206 can include both public and/or private databases. The database 208 is operable to store and manage identity, profile, and/or credit history of the individual, wherein such information may include but is not limited to, credit scores, transaction history, reported incidents or issues regarding previous transactions made by the individual. In addition, the database may also contain KBA questions and answers or the database may be used to generate KBA questions and answers tailored to each individual's credit and/or transaction history. Here, the term database is used broadly to include any known or convenient means for storing data, whether centralized or distributed, relational or otherwise. Due to their sensitive nature, records in the credit database 208 should be highly secured and optionally encrypted. Such record can be indexed and be made searchable via any of the information of the individual, such as credit card number, social security number, name, or telephone number upon request. In one embodiment, the KBA questions do not contain personally identifying information, but rather person-specific information, and therefore does not compromise the security of the credit reporting engine 206 or database 208 or the individual's identity. In one embodiment, the selection of KBA questions to ask the individual varies from one transaction to another, thereby limiting the potential damage if the KBA questions and their answers are somehow intercepted or otherwise compromised. In one environment, sensitive personally identifying information, such as social security number, are not disclosed by the credit reporting engine 206, but rather are used internally to generate KBA questions and answers, which are much less sensitive that the personally identifying information.

In the example of FIG. 2, the third identity validation engine 204 will decline to confirm the identity of the individual if validation is not completed within an allotted time span (such as due to slow response by the individual) or is denied because the rating/grading of the responses to the KBA questions by the credit reporting engine 206 is negative. Consequently, the online merchant engine 202 will be alerted of a potential identity theft and the transaction initiated by the individual will be declined to avoid financial losses to the merchant engine 202. In one embodiment, if the rating of the responses to the questions by the individual is positive (and preferably, timely), the third identity validation engine 204 will not only notify the merchant engine 202 that the individual's identity has been verified, it will also request an insurance policy covering the online transaction initiated by the individual from an insurance engine 210, and provide a digital certificate of such insurance policy to the online merchant engine 202. Such insurance policy will offer the online merchant engine 202 with additional protection in case the transaction is reversed because of identity fraud and any future claim is required. In one embodiment, the third identity validation engine 204 will record/log details of every transaction being insured or declined in its own database (not shown).

In one embodiment of FIG. 2, the insurance engine 210 is operable to authorize the insurance policy automatically and issue the digital certificate of the insurance instantly based on the confirmation of the identity of the individual provided by the third-party identity validation engine 204, thus shielding the online merchant engine 202 from the need of filling out any paper forms manually and waiting for the often time consuming approval by the insurer. Issuing such insurance policy would present minimal risk to the insurance engine 210 due to the high level of confidence on the authenticity of the individual's identity based on the extra layer of validation offered by the third-party identity validation engine 204. In addition, the insurance policy issued can be for each online transaction conducted or an umbrella policy, which covers a group of transactions conducted by the online merchant engine 202. An umbrella policy would further reduce the risk to the insurance engine 210 and the cost to the online merchant engine 202. In one embodiment, the merchant associated with the online merchant engine may choose to self-insure against losses, as the losses have been reduced by use of the third-party identity validation engine 204. In that embodiment, no transaction-specific insurance policies or certificates need to be issued and the third-party identity validation engine 204 will either approve or decline the transaction based on the validation result of the identity of the individual and communicate such decision to the online merchant engine 202.

In some embodiments, the third-party validation engine 204 may allow the individual to select a subset of a group of pre-selected questions for which he/she will provide personalized answers. The answers, as well as the subset of questions selected, will be associated with the individual's profiles and be maintained in the credit database 208 or in a local database of the third-party validation engine 204. These questions may be in addition to the KBA questions or instead of one or more KBA questions. The third-party validation engine 204 may choose among the subset of a group of pre-selected questions to use with a given request. The third-party validation engine may also allow to individual to include a custom question along with the personalized answer in the individual's profile. When the identity of the individual is to be validated the next time he/she initiates a transaction, one or more of these personal challenge questions and unique answers may be matched with their previous answers in addition to one or more of KBA questions generated from the individual's credit profile.

In some embodiments, the third-party validation engine 204 may utilize an interactive voice response (IVR) system for the validation process. The individual may be required to register his/her voice in a database for validation purposes. In some embodiments, the individual may be required to “voice print” him/herself multiple times. Then the individual is required to answer the KBA questions during validation, he/she must first vocally validate him/herself and the third-party validation engine 204 will match the voice with the voice print stored with the individual's profile. The validation process will proceed only when a match between the voices is found.

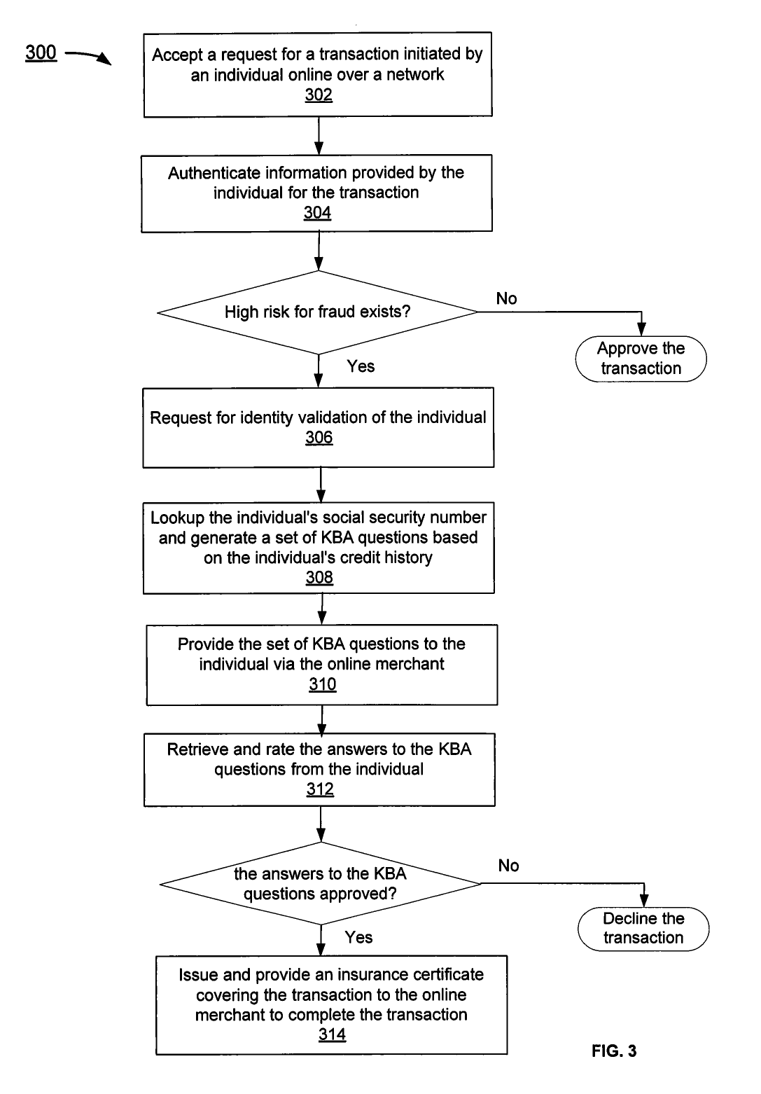

FIG. 3 depicts a flowchart of an example of a process to support user identity validation for online transactions. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 where an online merchant engine or merchant acquiring engine accepts a request for a transaction initiated by an individual online with over a network. In one embodiment, the individual is physically present at the merchant's store or facility. The flowchart 300 continues to block 304 where the online merchant engine authenticates the information provided by the individual for the transaction. If the online merchant engine 202 or a risk management engine 203 (which may be provided by some third party, which may or may not be the same third party as provides the identity validation engine, and may or may not be separate from the online merchant engine) determines that the risk for fraud is low, the transaction is approved. Otherwise, the flowchart 300 continues to block 306 where identity validation is requested to a third-party validation engine and some of the information of the individual, such as name, address, and telephone number, is provided to the validation engine. The flowchart 300 continues to block 308 where a reverse lookup is performed at a credit reporting engine to obtain the individual's social security number and a set of KBA questions are generated based on the individual's credit history. The flowchart 300 continues to block 310 where the set of KBA questions are provided to the individual via the online merchant engine. The flowchart 300 continues to block 312 where the answers to the KBA questions are retrieved from the individual and rated by the credit reporting engine. If the answers to the KBA questions are not approved by the credit reporting engine, the transaction is declined. Otherwise, the flowchart 300 ends block 314 where an insurance certificate covering the transaction is issued and provided to the online merchant engine to complete the transaction with the individual. It is understood that the variations described for FIG. 2 and elsewhere herein remain unaffected and also apply to flowchart 300.

In some embodiments, the individual may intend to have his/her identity validated in order to have his/her credit (or debit or prepaid) cards monitored, instead of having an online transaction approved. Under such a scenario, once the individual is able to answer the set of KBA questions correctly, his/her identity is validated and the individual is allowed to have a set of credit or debit or prepaid cards registered as legally owned by him/her and the activities associated with each of the cards can be monitored Similar to the flow depicted in FIGS. 2 and 3. In some embodiments, the individual is also allowed to set a daily purchase limit for each of the cards being monitored or a threshold of transaction count, transaction size, or periodic aggregate transaction value, beyond which threshold the identity validation described herein is invoked as if high risk for fraud exists. In some embodiments, the issuing bank (the bank that issued the credit card) initiates the identity validation described herein. In some embodiments, the third-party identity validation engine is operated by the online merchant engine, the issuing bank, or a credit reporting entity (e.g., Experian).

If any suspicious transaction is detected, such as a transaction via a card which amount exceeds the preset limit of the card, an alert can be sent to the individual, such as by email or cellular phone message, he/she will be given a short period of time (e.g., 5 minutes) to respond. Once the alert has been sent, transactions with one or more of the cards registered will be suspended by default. The individual may either accept or deny the transaction upon receiving the alert. If a deny response is given, the individual may elect to suspend only that card or all cards monitored. In some embodiments, the individual may choose to respond via one or more of: SMS, which is recommended only in those cases where the individual's mobile phone has a soft lock to prevent theft and subsequent fraudulent responses, email, where the individual logs onto a credit protection site and validate him/herself before responding, and voice or IVR alert, where the individual would be asked to state his/her name and that response may be compared to the voiceprint stored as well as the telephone number registered by the individual in the database.

In some embodiments, the individual may intend to have the identity of the other party involved in an online transaction validated in addition to his/her own identity. Such needs for identification may arise in cases involving P2P (peer to peer) electronic commerce commonly transacted on sites such as eBay, Craigslist or Amazon Marketplace or in interpersonal transactions on an online community site, such as those offered on dating sites as Match.com or a job or contract work matching site. When an individual desires to have the other party in an online transaction verified, the individual may enter selected personally identifying information, such as his/her name, home address, home and mobile telephone number, and agree to have his/her personal data accessed as well as pay any fee imposed for the validation service. Similar to the flow depicted in FIGS. 2 and 3, a reverse social security number lookup is performed to identify a profile that exists in both public and/or private databases to create a set of KBA questions that are then automatically presented to the individual whose identity is to be validated. In one embodiment, the individual has a time-limited window to correctly reply to the questions after which they are graded for accuracy. If all questions are answered correctly then the individual's identity is validated. Once validated, the first individual may then ask the other party with whom he/she is transacting with to be verified as well. An email is sent to the other party and the other party has to go through the same (or comparable) verification process within a certain period of time. The time limit for the validation process of the other party may be measured from when the second party responds to the request for personally identifying information. If and when both parties are verified, a notification is sent to both parties indicating that the transaction between them may proceed with minimal or no risk of identity fraud. Selected personally identifying information regarding the other party may be provided to the individual as part of the notification. Selected personally identifying information on the individual may be provided to the other party as part of the request for the identity of the other party to be validated. Information regarding the individual and/or the second party, where such information may include personally identifying information, may be retained for future reference or for providing to an authority, such as the police, or the entity operating the electronic commerce or online community site, or on whose behalf the electronic commerce or online community site is operated. This information may be retained by the electronic commerce or online community site or by a third party. In one embodiment, the personally identifying information reported to the individual, the second party, or retained is limited to that information provided by the individual or the second party for identifying that person to the third-party identity validation engine.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CO-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the embodiments of the claimed subject matter has been provided for the purposes of illustration and description. It is not intended to be exhaustive or to limit the invention to the precise forms disclosed. Many modifications and variations will be apparent to the practitioner skilled in the art. The same functions may be further distributed, involve additional parties, multiple parties may perform the same role, a party may perform multiple roles or functions, and/or functions may be performed by one entity on behalf of another entity identified herein. An insurance policy issued to an online merchant engine may be issued to the entity owning or operating (or on whose behalf the online merchant engine is operated) the online merchant engine, and the online merchant engine may or may not record information regarding the insurance policy. When a service operates an online merchant engine for multiple merchants, the service may be considered the merchant, or the usage of the online merchant engine for each of the individual merchants may be treated as a separate online merchant engine. A risk management engine may be part of the online merchant engine or a separate component, perhaps operated by the entity that operates the third-party identity validation engine. Particularly, while the concept “interface” is used in the embodiments of the systems and methods described above, it will be evident that such concept can be interchangeably used with equivalent software concepts such as, class, method, type, module, component, bean, module, object model, process, thread, application programming interface, networking interface, and other suitable concepts. Embodiments were chosen and described in order to best describe the principles of the invention and its practical application, thereby enabling others skilled in the art to understand the invention, the various embodiments and with various modifications that are suited to the particular use contemplated. Credit cards here include debit cards, stored value cards, smart cards, or any other card or device that identifies an individual or group of individuals to enable that individual or group of individuals to make purchases of goods or services, obtain cash or cash equivalents, or transfer money. It is intended that the scope of the invention be defined by the following claims and their equivalents.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A system, comprising:
an online merchant engine operable to:
accept a request for a transaction initiated by an individual online;
request for authentication of information of the individual required to complete the transaction;
a risk management engine operable to:
determine risk of identity fraud for the transaction;
a third-party validation engine operable to:
request for validation of identity of the individual if the risk of fraud is high;
request and provide an insurance policy covering the transaction to the online merchant engine if the identity of the individual is approved;
a credit reporting engine operable to validate the identity of the individual based on certain information of the individual provided by the validation engine;
an insurance engine operable to issue the insurance policy covering the transaction automatically if the identity of the individual is approved.

2. The system of claim 1, further comprising:
a credit database coupled to the credit reporting engine, wherein the credit database is operable to store and manage identity and/or credit history of the individual.

3. The system of claim 1, wherein:
the online merchant engine, the third-party validation engine, the credit reporting engine, and the insurance engine communicates over a network via communication interfaces and/or application programming interfaces (APis).

4. The system of claim 1, wherein:
the risk management engine determines the risk of identity fraud based on a set of rules and limitations.

5. The system of claim 1, wherein:
the certain information required to validate the identity of the individual includes one or more of: first and last name, address, and phone number of the individual.

6. The system of claim 1, wherein:
the credit reporting engine is operable to authenticate the information of the individual required to complete the transaction.

7. The system of claim 1, wherein:
the credit reporting engine is operable to perform a reverse lookup on social security number of the individual based on certain information of the individual.

8. The system of claim 1, wherein:
the credit reporting engine is operable to generate a set of knowledge based authentication (KBA) questions based on profile and/or credit history and/or transaction history of the individual for the validation of identity of the individual.

9. The system of claim 8, wherein:
the third-party validation engine is operable to provide the set of KBA questions to and retrieve responses to the set of KBA questions from the individual.

10. The system of claim 9, wherein:
the third-party validation engine is operable to deny the identity of the individual if the individual does not respond to the KBA questions in a timely manner.

11. The system of claim 9, wherein:
the credit reporting engine is operable to validate the identity of the individual by grading the responses to the set of KBA questions from the individual.

12. The system of claim 11, wherein:
the third-party validation engine is operable to approve or deny the identity of the individual based on the grading of the responses to the set of KBA questions from the individual and notify the online merchant to complete or decline the transaction accordingly.

13. The system of claim 1, wherein:
the third-party validation engine is operable to record details of the transaction being insured.

14. The system of claim 1, wherein:
the third-party validation engine is operable to deliver a digital certificate of the insurance policy instantly to the online merchant engine.

15. The system of claim 1, wherein:
the third-party validation engine is operable to allow the individual to select a subset of a group pre-selected questions for which the individual provides personalized answers.

16. The system of claim 1, wherein:
the third-party validation engine is operable to utilize an interactive voice response (IVR) system for the validation process.

17. The system of claim 1, wherein:
the third-party identity validation engine is operable to interact with the individual using an interface, device, network, or medium different than that used for the individual to interact with the online merchant engine.

18. A system, comprising:
an online merchant engine operable to:
accept a request for a transaction initiated by an individual online;
request for authentication of information of the individual required to complete the transaction;
a risk management engine operable to:
determine risk of identity fraud for the transaction;
a third-party validation engine operable to:
request for validation of identity of the individual if the risk of fraud is high;
approve or decline the transaction based on validation result of the identity of the individual;
a credit reporting engine operable to validate the identity of the individual based on certain information of the individual provided by the validation engine.

19. A method, comprising:
accepting a request for a transaction initiated by an individual online over a network;
authenticating information provided by the individual for the transaction;
validating identity of the individual if high risk for fraud exists;
completing or declining the transaction based on validation result of the identity of the individual;
issuing and providing an insurance certificate covering one or more transactions for which the identity of the individual involved is validated.

20. The method of claim 19, further comprising:
validating the identity of the individual by:
looking up the individual's social security number reversely using some of the information of the individual;
generating a set of knowledge based authentication (KBA) questions based on the individual's profile and/or credit history;
presenting the set of KBA questions to the individual;
retrieving and grading answers to the KBA questions from the individual;
approving or denying the identity of the individual based on the graded answers to the KBA questions from the individual.
